(19) United States
(12) Patent Application Publication
(10) Pub. No.: US 2017/0109015 A1
(43) Pub. Date: Apr. 20, 2017

(54) CONTEXTUAL ATHLETE PERFORMANCE ASSESSMENT

(71) Applicant: MICROSOFT TECHNOLOGY LICENSING, LLC, Redmond, WA (US)

(72) Inventor: Georgios Krasadakis, Dublin (IE)

(21) Appl. No.: 14/882,976

(22) Filed: Oct. 14, 2015

(51) Int. Cl. G06F 3/0484; G06F 17/30

(52) U.S. Cl. CPC G06F 3/04842; G06F 17/3053; G06F 17/30595

(57) ABSTRACT

Aspects of the technology described herein can efficiently identify athletes that satisfy a user's performance profile as determined by a customized performance score. The athlete performance score can be calculated according to performance variables selected by a user and weights given to the performance variables by the user. The athlete performance score can be used to identify athletes that score well under the selected variables and weights. The variables can include known sports statistics, explicit physical characteristics, implicit performance estimators, and publicity trends across social media.

### BACKGROUND

Athletic performance can be measured in various ways. For example, sports statistics can measure an athlete's performance during sporting events. Using baseball as an example, a batter's performance could be measured by traditional statistics, such as runs batted in (RBIs), batting average, walks, strikeouts, and home runs. A batter's performance could also be measured by composite statistics that are calculated using a variety of inputs. Exemplary composite statistics for baseball comprise equivalent average (EQA) and Base Runs (BsR). Fans can have different opinions about which statistics, or combination of statistics, best measure overall baseball athletes' performance in a specific context or scenario.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The technology described herein provides a mechanism for generating a customized weighted athletic performance score, which is then used for athlete discovery, comparison, and reporting. Aspects of the technology described herein can efficiently identify athletes that satisfy a user's idea of a good overall performance as determined by a customized overall performance score (a single score over numerous performance variables, each adjusted by user-defined importance/weight factor). The athlete performance score can be calculated according to performance variables as weighted by the user, where each weight factor reflects the importance of the performance variable as set by the user. The athlete performance score can be used to identify athletes that score well in a specific context/scenario defined by the specific combination of weight factors on the corresponding variables. The performance variables can include known sports statistics. The discovery mechanism can further combine an athlete's explicit physical characteristics, implicit physical characteristics, and publicity trends.

In one aspect, a user is able to browse various available variables of an athlete's performance (as set for the specific sport). The variables may be specific to a sport, such as soccer, baseball, football, basketball, volleyball, track, swimming, cricket, and such. A user is then able to provide a weight factor to be applied to each of the performance variables. A performance score can then be calculated for each athlete in a designated talent pool, as a function of all the available variables, adjusted by user's weight factors. The overall adjusted performance score is then used to rank the athletes in the talent pool, which provides a new way to discover athletes based on this customized (adjusted) overall performance.

### BRIEF DESCRIPTION OF THE DRAWINGS

Aspects of the technology described in the present application are described in detail below with reference to the attached drawing figures, wherein:

FIG. 1 is a block diagram of an exemplary computing environment suitable for implementing aspects of the technology described herein;

FIG. 2 is a diagram depicting an exemplary computing environment including an athlete's performance computation engine, in accordance with an aspect of the technology described herein;

FIG. 3 is a diagram depicting an athlete's performance search engine interface, in accordance with an aspect of the technology described herein;

FIG. 4 is a diagram depicting a method of generating an athlete performance score, in accordance with an aspect of the technology described herein;

FIG. 5 is a diagram depicting a method of generating an athlete performance score, in accordance with an aspect of the technology described herein;

FIG. 6 is a diagram depicting a method of generating an athlete performance score, in accordance with an aspect of the technology described herein; and

FIG. 7 is a block diagram of an exemplary computing environment suitable for implementing aspects of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein provides a mechanism for generating an overall, customized athlete performance score, and using it to enable advanced search and discovery scenarios. Aspects of the technology described herein can efficiently identify athletes that satisfy a user's idea of a good performance as determined by a customized performance score against numerous performance variables. The athlete performance score can be calculated according to performance variables as weighted by the user, where each weight factor reflects the importance of the performance variable as set by the user. The athlete performance score can be used to identify athletes that score well under the specific combination of weights on the performance variables. The performance variables can include known sports statistics. The discovery mechanism can further combine an athlete's explicit physical characteristics, implicit physical characteristics, and publicity trends.

In one aspect, a user is able to define the significance for each of the variables describing an athlete's performance. The variables may be specific to a sport, such as soccer, baseball, football, basketball, volleyball, track, swimming, cricket, and such. A user is then able to provide a weight factor to be applied to each of the applicable performance variables. A performance score can then be calculated for each athlete in a designated talent pool. A list of athletes having the highest performance score calculated using the variables as weighted by the user can then be displayed.

The talent pool can also be defined by a user. In one aspect, an interface is provided that allows the user to define a talent pool. A talent pool can be defined by a sport, a league, a team, a time frame, as well as with other characteristics, in any combination. For example, a talent pool could be limited to American League baseball athletes. In another aspect, the talent pool could be limited to a particular team. In another aspect, the talent pool could be limited by a time frame, including historical time frames. For example, the talent pool could be limited to baseball athletes that played Major League baseball during the 1956 season. A user can name, save, retrieve, and share the talent pool

The technology described herein can also generate indirect estimates (measures) of an individual athlete's performance. Once such measure can be estimated through publicity data that describes the amount, and possibly the quality or the emotional load of mentions the athlete receives in published commentary, including discussions across social media. Characteristics, such as position on a team, of the athlete can also be used to generate a baseline amount of mentions and then the baseline can be compared to the athlete's current mentions. For example, a quarterback could have a much higher baseline of mentions than an offensive lineman. The quarterback could be compared to the baseline for quarterbacks and the offensive lineman could be compared to the baseline for offensive linemen. An athlete that is playing very well is likely to receive more mentions in published commentary. As used herein, published commentary comprises news articles, blog posts, or social media that describes a sporting event in which an athlete participated. Additional input for commentary could include: live feeds as provided by 3^{rd} parties and integrated to the system; or archived feeds/commentary which are processed in a batch mode to evaluate mentions and generate the publicity indicators as an additional signal of an athlete's performance. When the natural language processor (NLP) uses live commentary to identify mentions for the player and their positive/negative value, it can also associate the mentions with specific events within the game. It then estimates the significance of the event within the game (how critical was this goal for the match) and then the significance of the match for the league (for instance, was it a final in champions league), and further adjusts the mention/publicity of the athlete being mentioned. That is, a winner-changing goal scorer at the very last minute of the Champion's league final will be adjusted accordingly (versus a same scenario, in a routine game, or a random moment of a less significant league).

The publicity indicator may also take into account whether the commentary was positive or negative. The emotional load and the implied level of performance can be determined from a social mention or discussion using a natural language processor that first identifies a commentary mentioning an athlete and then determines, based on the context of the comment or discussion, whether or not the mention is positive or negative (with levels) and also the implied level of performance. In one aspect, the natural language processor is a machine-learning model that is trained using annotated sports articles that classify athlete mentions as positive or negative.

Natural language processing can also be used to derive various implicit classifications that can be used as performance variables Implicit classifications include an athlete's speed, strength, physical endurance, and sports intelligence. These implicit characteristics can be derived from commentary describing the athlete and the athlete's activity/performance. For example, an athlete that is described as slow, plodding, or similar could receive a speed score corresponding to slow. Similarly, an athlete described as winded, or needing a rest, could be described as in poor physical condition. In one aspect, an athlete starts with a normal rating in these categories and then the rating is moved up or down as commentary is evaluated. The athlete's implicit characteristics may be adjusted for position according to baselines. For example, a wide receiver is likely to be faster than an offensive lineman.

In one aspect, the implicit classification can be generated by looking at statistics that can shed light on the implicit talent indicator. For example, a large number of stolen bases in baseball may be a proxy for excellent speed. Similarly, excellent defensive statistics for an outfielder in baseball could be used as a proxy for speed when calculating the implicit classification. The implicit classification is described as implicit because speed is not directly measured, for example, in a 40 yard dash, 100 yard dash, or similar.

Aspects of the technology described herein may also use explicit performance metrics, such as those recorded in a sporting combine, such as the NFL combine. An athlete's 40 yard dash time, bench press reps, and other measure could be explicit metrics.

In one aspect, the technology allows users to generate groups of athletes to be monitored on an on-going basis. For example, a user may generate a list of athletes with a high performance score or take the top 10% of the athletes based on the overall adjusted performance score. Individual athletes on the list that are of particular interest to the user may be selected for monitoring. When the user returns to the performance interface, the user can recall individual talent pools to see if those scores for those athletes have changed. In one aspect, the performance score for athletes can be graphed as it changes over time, using time series analysis and visualization techniques.

Having briefly described an overview of aspects of the technology described herein, an exemplary operating environment suitable for use in implementing the technology is described below.

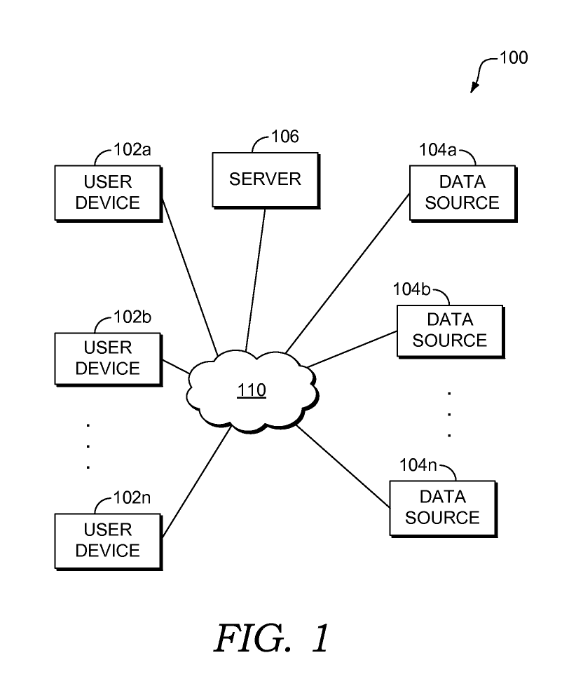

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

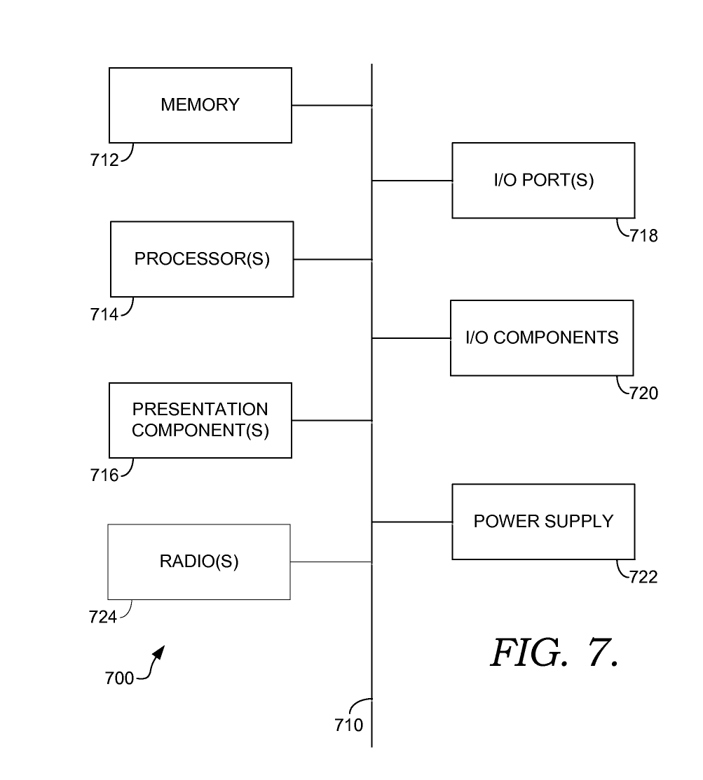

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 700 described in connection to FIG. 7, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can provide numeric weights for adjusting an overall performance score and receive a ranked list of athletes according to their performance scores. In one aspect, the browser application on the user devices accesses an athlete performance search engine web page hosted by the server 106.

Server 106 can comprise server-side software designed to work in conjunction with client-side software on user devices 102a and 102b through 102n so as to implement any combination of the features and functionalities discussed in the present disclosure. For example, the server 106 may run an athlete performance computation engine, such as the athlete-performance computation engine 220, that generates an overall customized performance score for each athlete. This division of operating environment 100 is provided to illustrate one example of a suitable environment, and there is no requirement for each implementation that any combination of server 106 and user devices 102a and 102b through 102n remain as separate entities.

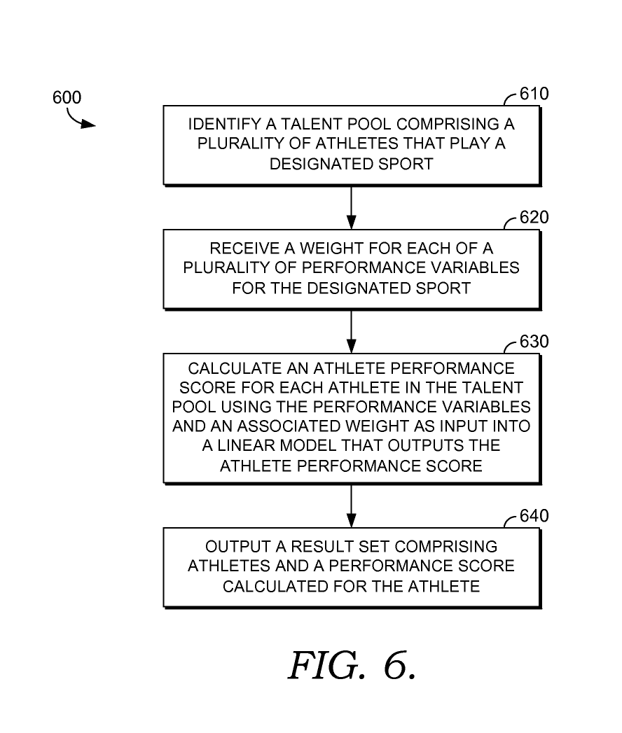

User devices 102a and 102b through 102n may comprise any type of computing device capable of use by a user. For example, in one aspect, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

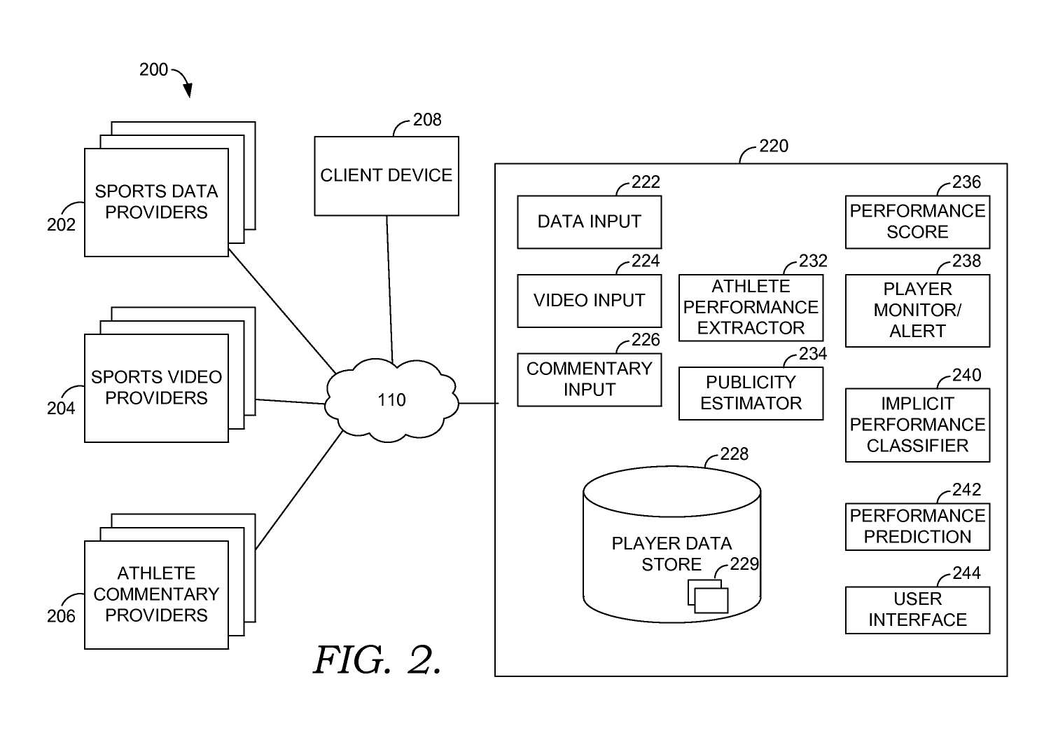

Data sources 104a and 104b through 104n may comprise data sources and/or data systems, which are configured to make sports data available to any of the various constituents of operating environment 100, or system 200 described in connection to FIG. 2. (For example, in one aspect, one or more data sources 104a through 104n provide (or make available for accessing) sports statistics data to athlete-performance computation engine 220 of FIG. 2.) Data sources 104a and 104b through 104n may be discrete from user devices 102a and 102b through 102n and server 106 or may be incorporated and/or integrated into at least one of those components. The data sources 104a though 104n can comprise a knowledge base that stores information about a sport, a league, sports news, sports videos, etc.

Operating environment 100 can be utilized to implement one or more of the components of system 200, described in FIG. 2, including components for collecting user data, monitoring events, generating performance scores, applying performance weight factors on variables, and generating ranked lists of athletes (talent pools) based on their performance scores.

Referring now to FIG. 2, with FIG. 1, a block diagram is provided showing aspects of an example computing system architecture suitable for implementing an aspect of the technology described herein and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including sports data providers 202, sports video providers 204, and athlete commentary data providers 206, client device 208, and athlete-performance computation engine 220. Athlete-performance computation engine 220 (including its components 222, 224, 226, 228, 232, 234, 236, 238, 240, 242, and 244) may be embodied as a set of compiled computer instructions or functions, program modules, computer software services, or an arrangement of processes carried out on one or more computer systems, such as computing device 700 described in connection to FIG. 7, for example.

In one aspect, the functions performed by components of system 200 are associated with one or more applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some aspects functionality of these components can be shared or distributed across other components.

The sports data providers 202, sports video providers 204, and athlete commentary data providers 206 each provide data that can be used to calculate or adjust a performance score. The sports data providers 202 provide sports statistics that describe an athlete's performance in games across various competitions. Different data support providers may be used to provide information about different sports and for different markets (countries and languages). In an aspect, data providers can provide statistical information about the same sport. The sports data can be provided in the form of an attribute value pair or a more complex data structure such as serialized object with embedded lists of items/elements. The attribute may be a performance variable, such as runs scored, and the value can be the number of runs scored, such as 50. The sports data may be communicated to the data input component 222. The data input component can format the sports data into a schema useful for generating a performance score and store the data in data store 228. In one aspect, the sports data is used to generate athlete profiles 229. The athlete profiles 229 can include both performance data and athlete characteristics, including explicit performance estimators and implicit performance estimators.

The performance data can include statistics from an athlete's events. Different sports can include different statistics. Baseball statistics can measure hitting, pitching, and fielding. A partial list of hitting statistics that can be used by the technology described herein includes (with common abbreviation in parenthesis): At Bats (AB), Walks (BB), Batting Average (AVG), Hits (H), Singles (1B), Doubles (2B), Triples (3B), Home Runs (HR), Runs (R), Runs Batted In (RBI), Hit By Pitch (HBP), Games Played (G), Plate Appearances (PA), Reached on Error (ROE), Fielder's Choice (FC), Stolen Bases (SB), Caught Stealing (CS), Left On Base (LOB), Strikeouts (K), Sacrifice Hit (SAC), Ground Into Double Play (GIDP), Times On Base (OB), Total Bases (TB), Extra Base Hits (XB), On-Base Percentage (OBP), Slugging Percentage (SLG), Stolen Base Percentage (SBP), and On Base Percentage Plus Slugging (OPS).

A partial list of pitching statistics that can be used by the technology described herein include: Appearances (App), Balks (BK), Balls (B), Batters Faced (BF), Batters Hit By Pitch (HBP), Blown Saves (BS), Complete Games (CG), Doubles Allowed (2B), Earned Run Average (ERA), Earned Runs Allowed (ER), Fly Balls (FB), Ground Ball/Fly Ball Ratio (G/F), Ground Balls (GB), Hold (HLD), Home Runs Allowed (HR), Innings Pitched (IP), Losses (L), Runs Allowed (R), Saves (S), Singles Allowed (1B), Strikeouts (K), Strikes, Triples Allowed (3B), Walks (BB), Walks and Hits Per Inning Pitched (WHIP), Wild Pitches (WP), and Wins (W).

A partial list of exemplary fielding statistics that can be used by aspects of the technology described herein comprise: Assists (A), Double Plays (DP), Errors (E), Fielding Percentage (FLDP), Games Played (G), Innings Played (Inn), Passed Balls (PB), Put Outs (PO), Range Factor (Range), Runners Caught Stealing (CS), Stolen Bases Allowed (SB), and Total Chances (TC).

A partial list of basketball statistics that can be used by the technology described herein include: 3PA—Three Pointers Attempted, 3PM—Three Pointers Made, 3PP—Three Point Percentage, APG—Assists per Game, AST—Total Assists, AV—Approximate Value, BLK—Blocks, EFF—Efficiency, FGA—Field Goals Attempted, FGM—Field Goals Made, FGP—Field Goal Percentage, FTA—Free Throws Attempted, FTM—Free Throws Made, FTP—Free Throw Percentage, G—Games Played, MM—Minutes Played, MPG—Minutes Per Game, PF—Total Personal Fouls, PPFGA—Points Per FGA, PPG—Points Per Game, PPR—Assist/Turnover Rating, Pts—Total Points, RbRate—Rebound Rate, REB—Total Rebounds, RPG—Rebounds Per Game, STL—Steals, TO—Turnovers, and VI—Versatility Index.

A partial list of golf statistics that can be used by the technology described herein include: 100=Proximity to the Hole 100-125 Yards, 125=Proximity to the Hole 125-150 Yards, 150=Proximity to the Hole 150-175 Yards, 175=Proximity to the Hole 175-200 Yards, 200+=Proximity to the Hole 200+ Yards, 75=Proximity to the Hole 75-100 Yards, BA=Bogey Avoidance, BoB %=Birdie or Better %, DA=Driving Accuracy, DD=Driving Distance, GIR=Greens In Regulation, P3=Par 3 Scoring, P4=Par 4 Scoring, P5=Par 5 Scoring, PROX=Proximity to the Hole—All Approaches, SCR=Scrambling, SGP=Strokes Gained Putting, SS %=Sand Save Percentage, T2G=Strokes Gained Tee to Green, TD=Total Driving.

A partial list of cricket statistics that can be used by the technology described herein include: Balls faced (BF), Balls (B), Batting average (Ave), Best Bowling in Innings (BBI), Best Bowling in Match (BBM), Best bowling (BB), Bowling analysis (BA or OMRW), Bowling average (Ave), Catches (Ct), Centuries (100), Economy rate (Econ), Five wickets in an innings (5w), Four wickets in an innings (4w), Half-centuries (50), Highest Score (HS/Best), Innings (I), Maiden overs (M), Matches (Mat/M), Net Run Rate (NRR), No balls bowled (Nb), Not Outs (NO), Overs (O), Run Rate (RR), Runs (R), Strike Rate (SR) (the average number of balls bowled per wicket taken (SR=Balls/W)), Stumpings (St), Ten wickets in a match (10w), Wickets (W), and Wides (Wd).

A partial list of football passing statistics that can be used by the technology described herein include: Attempts (Att), Completion Percentage (Pct), Completions (Comp), First Down Passes (FD), Interceptions (Int), Longest Pass Play (Long), Passer Efficiency (Eff), Passer Rating (Rating), PAT Conversion Points (PAT), Sacks (Sck), Touchdowns (TD), Yards (Yds), Yards Lost (YL), Yards Per Attempt (YPA), and Yards Per Game (YPG).

A partial list of football rushing statistics that can be used by the technology described herein include: Attempts (Att), First Downs (FD), Fumbles (Fum), Fumbles Lost (Lost), Longest Rush (Long), PAT Conversion Points (PAT), Touchdowns (TD), Yards (Yds), Yards Per Attempt (YPA), and Yards Per Game (YPG).

A partial list of football defensive statistics that can be used by the technology described herein include: Assist Tackles (Ast), Forced Fumble (FF), Fumble Recovery (FR), Fumble Recovery TD (FRTD), Fumble Recovery Yards (FRY), Interception TD (Int TD), Interception Yards (Int Yds), Interceptions (Int), Penalties (Pen), Penalty Yards (Pen Yds), Sacks (Sack), Solo Tackles (Solo), Tackle for Loss (TFL), and Tackles (Tkl).

A partial list of football kicking statistics that can be used by the technology described herein include: Avg Punt Yards (Punt Avg), Blocked Kicks (Blk), FG Blocked (FG Blk), Field Goal Attempts (FG Att), Field Goal Percentage (FG %), Field Goals Made (FG), Kick Returns (KR), KR Avg Yards (KR Avg), KR Longest (KR Long), KR Yards (KR Yds), Longest Field Goal (FG Long), Longest Punt (Punt Long), PAT Attempts (PAT Att), PAT Made (PAT), Penalties (Pen), Penalty Yards (Pen Yds), PR Avg Yards (PR Avg), PR Fair Catches (FC), PR Longest (PR Long), PR Yards (PR Yds), Punt Inside 20 (<20), Punt Returns (PR), Punt Yards (Punt Yds), and Punts (Punts).

A partial list of football defensive statistics that can be used by the technology described herein include: Assists (A), Blocked Shots (Blk), Catches and Punches (CP), Cautions (C), Corner Kick (CK), Ejections (EJ), Fouls Committed (FC), Fouls Sustained (FS), Game Winning Assist (GWA), Game Winning Goal (GWG), Games Played (GP), Games Started (GS), Goals (G), Goals Allowed (GA), Goals Allowed Average (GAA), Hat Trick (Hat), Losses (L), Minutes played (MIN), Offside (OFF), Overtime Losses (OTL), Overtime Minutes (OTM), Overtime Wins (OW), Penalty Kick Attempts (PA), Penalty Kick Goals (PG), Points (Pts), Save Avg (SA), Save Pct (SPct), Save Ratio (SR), Saves, Shooting Percentage (Pct), Shots (Sh), Shots On Goal (SOG), Shutouts (SHO), Steals (SU), Ties (T), and Wins (W).

The sports video providers 204 provide videos of an athletic competition in which an athlete of interest participated. Exemplary sports video providers include sports networks and sports leagues and online media sites. The videos provided can be evaluated to generate athlete performance classifications that can be included when calculating a performance score. The sports video providers 204 can communicate the videos to video input component 224. The video input component 224 can index the videos and communicate them to data store 228 for further storage. The videos can be processed by video athlete performance extractor 232. The video athlete performance extractor 232 can perform a frame-by-frame analysis to estimate the speed of an athlete, the total distance covered by the athlete or even the energy levels of the athlete during an athletic event. The estimation on speed derived from the analysis can be used to assign/classify the athlete in terms of performance, such as a fast or slow runner.

The athlete commentary data providers 206 include newspapers, sports websites, blogs, search engines, and third-party companies providing live feed/commentary under special agreement. Sports commentary comprises content or textual descriptions of events that describe a sporting performance including athletes evaluated by the athlete-performance computation engine 220. The athlete commentary data providers 206 can communicate sports commentary to commentary input component 226. In one aspect, commentary input component 226 comprises a web crawling functionality that searches for and indexes published sports commentary, including discussions across social media. Relevant commentary can be stored in the data store 228. In another aspect, event (game) commentary is provided by a third-party company in a live or offline mode, under specific licensing/commercial agreement.

The commentary data can be analyzed by the implicit-performance classifier 240 and the publicity estimator 234 to generate data that describes aspects of an athlete's performance. The publicity estimator 234 can analyze trends in an athlete's level of reference/mentions in discussions across published commentary, including social media, to generate a publicity score. As mentioned previously, a simple version of an athlete's publicity score can be generated by comparing the athlete's publicity against a baseline, expected publicity. The athlete's publicity baseline can be generated by taking an average amount of publicity received by athletes that are similar to the athlete, in similar events, leagues, and markets. The plurality of athletes that are similar to the athlete being studied can be generated by analyzing characteristics of the athletes. As an example, a position played by the athlete can be used to generate a baseline by using publicity generated by other athletes playing the same position to determine an average publicity for the position. Other factors, such as a player's team, can be used to adjust the baseline. An athlete in a major media market should expect to receive more mentions (in the social media spectrum) than an athlete in a minor media market. In one aspect, a baseline of mentions is generated across markets and then a market factor is used to adjust the baseline according to an athlete's market. In one aspect, the publicity score is expressed as a percentage above or below the baseline.

The performance score component 236 generates a performance score according to an algorithm adjusted by the user. As mentioned, the performance score component 236 can use a group of performance weight factors during calculation of an adjusted overall performance score. This allows the performance score to be customized to the user. The selection can be done indirectly: If the user sets the significance to zero for a specific variable, then the variable is ignored in the calculation.

The following example is one way to calculate a performance score for a soccer player. The data used in the example for athlete k is shown below in table 1.

TABLE 1

| j = 1, 2, . . . , n | | | | | | | | |
|---|---|---|---|---|---|---|---|---|
| classes | | | | | | | | Standardized |
| organizing skills | i = 1, 2, . . . . , n Critical skills/ | | | | Normalized | | | performance |
| against player's | techniques against which | Raw data | | | per match | | | score |
| position | players are ‘measured’ | (counters) | | | played | | | (1 to 100) |
| Cⱼ | Sᵢ | F_{S} | F_{R} | F_{L} | F_{S*N} | F_{R*N} | F_{L*N} | SPS_{k,i} |
| General | Passing | F_{S,1} | F_{R,1} | F_{L,1} | F_{S*N,1} | F_{R*N,1} | F_{L*N,1} | SPS_{k,1} |
| j = 1 | Shooting | F_{S,2} | F_{R,2} | F_{L,2} | F_{S*N,2} | F_{R*N,2} | F_{L*N,2} | SPS_{k,2} |
| | Heading | . . . | . . . | . . . | . . . | . . . | . . . | . . . |
| | Trapping the ball | . . . | . . . | . . . | . . . | . . . | . . . | . . . |
| | Feint and dribble | . . . | . . . | . . . | . . . | . . . | . . . | . . . |
| | Ball control | . . . | . . . | . . . | . . . | . . . | . . . | . . . |
| | Running with the ball | . . . | . . . | . . . | . . . | . . . | . . . | . . . |
| | Turning | . . . | . . . | . . . | . . . | . . . | . . . | . . . |
| Attacking | Attacking play | . . . | . . . | . . . | . . . | . . . | . . . | . . . |
| j = 2 | Principles of attack | . . . | . . . | . . . | . . . | . . . | . . . | . . . |
| | Passing play | . . . | . . . | . . . | . . . | . . . | . . . | . . . |
| | 2-1 situations | . . . | . . . | . . . | . . . | . . . | . . . | . . . |
| | Runs | . . . | . . . | . . . | . . . | . . . | . . . | . . . |
| | Crosses | . . . | . . . | . . . | . . . | . . . | . . . | . . . |
| | Finishing | . . . | . . . | . . . | . . . | . . . | . . . | . . . |
| Defending | Principles of defense | . . . | . . . | . . . | . . . | . . . | . . . | . . . |
| j = 3 | 1-to-1 situations | . . . | . . . | . . . | . . . | . . . | . . . | . . . |
| | Defending around the | . . . | . . . | . . . | . . . | . . . | . . . | . . . |
| | box | | | | | | | |
| Goalkeeping | Movement techniques | . . . | . . . | . . . | . . . | . . . | . . . | . . . |
| technique | Catching the ball | . . . | . . . | . . . | . . . | . . . | . . . | . . . |
| j = 4 | Diving techniques | . . . | . . . | . . . | . . . | . . . | . . . | . . . |
| | Positioning | . . . | . . . | . . . | . . . | . . . | . . . | . . . |
| | Shot stopping | . . . | . . . | . . . | . . . | . . . | . . . | . . . |
| | Contending one on | . . . | . . . | . . . | . . . | . . . | . . . | . . . |
| | ones | | | | | | | |
| | Dealing with crosses | F_{S,n} | F_{R,n} | F_{L,n} | F_{S*N,n} | F_{R*N,n} | F_{L*N,n} | SPS_{k,n} |

The standardized performance of player k on the skill (aka performance variable) i is SPS_{k,i}. The average performance of player k across 1, 2, . . . , n skills is:

$${\overline{P}}_{k} = \frac{1}{n} {\sum }_{i = 1}^{n} {SPS}_{k , i} \qquad Equation 1$$

The average performance of player k across 1, 2, . . . , n skills, taking into consideration the player's position is:

$${\overline{P}}_{k / position} = \frac{1}{n} {\sum }_{i = 1}^{n} {WP}_{k , i} * {SPS}_{k , i} \qquad Equation 2$$

The weighted performance of a player k across 1, 2, . . . , n skills, taking into consideration user-defined weight is:

$${\overline{P}}_{k / user} = \frac{1}{n} {\sum }_{i = 1}^{n} {WU}_{i} * {SPS}_{k , i} \qquad Equation 3$$

where Wᵢ is the weight factor set by the user for the i^{th} skill and P_{k,i} is the standardized performance score for the player k on the i^{th} skill.

The weighted performance of player k across 1, 2, . . . , n skills, taking into consideration the player's position can be calculated using equation 4:

$${\overline{P}}_{k / position / user} = \frac{1}{n} {\sum }_{i = 1}^{n} {WP}_{k , i} * {WU}_{i} * {SPS}_{k , i} \qquad Equation 4$$

where WP_{k,i} is defined as explained in the following paragraphs.

Each specific player position, according to a specific sport, may have a certain combination of predefined (default) weight factors. For instance, in soccer for a striker/attacker, special weight will be given in Shooting, Finishing, etc. rather than Shot stopping. There are other skills like ball control which could be equally important (or almost) to any position. The following table presents how the system will allow configuring (setting up, once) the importance of each skill for every single position.

TABLE 2

| | Importance of skill when player's | | | |
|---|---|---|---|---|
| | position is . . . | | | |
| Skill i | General | Attacking | Defending | Goalkeeping |
| Passing | WP_{1,1} | WP_{1,2} | WP_{1,3} | WP_{1,4} |
| Shooting | WP_{2,1} | WP_{2,2} | WP_{2,3} | WP_{2,4} |
| Heading | . . . | . . . | . . . | . . . |
| Trapping the ball | . . . | . . . | . . . | . . . |
| Feint and dribble | . . . | . . . | . . . | . . . |
| Ball control | . . . | . . . | . . . | . . . |
| Running with the ball | . . . | . . . | . . . | . . . |
| Turning | . . . | . . . | . . . | . . . |
| Attacking play | . . . | . . . | . . . | . . . |
| Principles of attack | . . . | . . . | . . . | . . . |
| Passing play | . . . | . . . | . . . | . . . |
| 2-1 situations | . . . | . . . | . . . | . . . |
| Runs | . . . | . . . | . . . | . . . |
| Crosses | . . . | . . . | . . . | . . . |
| Finishing | . . . | . . . | . . . | . . . |
| Principles of defense | . . . | . . . | . . . | . . . |
| 1-to-1 situations | . . . | . . . | . . . | . . . |
| Defending around the | . . . | . . . | . . . | . . . |
| box | | | | |
| Movement techniques | . . . | . . . | . . . | . . . |
| Catching the ball | . . . | . . . | . . . | . . . |
| Diving techniques | . . . | . . . | . . . | . . . |
| Positioning | . . . | . . . | . . . | . . . |
| Shot stopping | . . . | . . . | . . . | . . . |
| Contending one on ones | . . . | . . . | . . . | . . . |
| Dealing with crosses | WP_{n,1} | WP_{n,2} | WP_{n,3} | WP_{n,t} |

The above are some basic linear computations/weighted averages enabling the generation of scores/weighted scores based on a user's input. These formulas are for example only—in practice, additional models can be used, such as composite statistical models or non-linear functions. All scores and formulas presented above refer to specific time moments or periods of time. The technology can perform an analysis of recent performance of the player, dynamics, trends, lifetime performance, gaps, peaks, and major changes in the patterns. The system will know the expected performance of each athlete against specific skills and overall (as a function of the recent performance, the lifetime performance, the dynamics, the current configuration—current game, the competitor(s), and related insights/machine-learning outputs).

The monitor component 238 can receive a request from the user to monitor the performance of an athlete or group of athletes. A user interface can be provided to show trends in performance for the athlete or group of athletes. The monitor component 238 can systematically scan calculated performance scores for the athlete or group of athletes and, if specific criteria are met, communicate these to the user through the preconfigured channel (for example email, smartphone application).

The implicit-performance classifier 240 uses natural language processing to analyze sports commentary to extract implicit classifications of an athlete in terms of performance. For example, an athlete described as quick, fast, speedy, or other similar terms could be assigned a fast speed as an implicit variable or class. Other terms could be mapped to other implicit performance classes. In one aspect, a corpus of sports commentary is annotated by human analysis to specify language that maps to a particular performance classification. This corpus of sports commentary can be used as training data for a natural language processor that is then able to take unlabeled sports commentary and make associations with implicit classes. The natural language processor may output the correlation with an implicit performance classification along with a confidence score. In one aspect, the correlating implicit performance classification is stored in an athlete's profile and also in the knowledge base along with a confidence score. The confidence score can be used in combination with the mapping to generate an implicit performance classification. In other words, the implicit performance classification of the athlete is done with a specific degree of strength. A similar analysis could be used for athlete strength, athlete sports intelligence, and other implicit performance variables.

The implicit-performance classifier 240 can execute data mining/machine-learning models against the large volumes of athlete performance data against a sufficient amount of time, in order to identify the relationship between certain skills, commentary mentions, and physical attributes of the athlete. In some cases, the performance against specific skills could be used to estimate athlete qualities such as speed, strength, accuracy, etc.

The athlete-performance predictor component 242 takes into account the detailed, rich information maintained at the player level and against time to calculate a predicted performance score. The predicted score can be expressed as an estimated athlete performance score. The athlete-performance predictor component 242 can model and use a significantly larger set of inputs (some of them could be unique in this context) including: the dynamics of the team performance, the dynamics of the opponent team performance, the dynamics of the league/season, a quantification of the shape of the Athlete, the trend of the shape of the Athlete, the position of the Athlete within his/her career, and additional factors affecting or correlated with the performance of the player, such as: a small set of key-players which affect the performance of the athlete when they are playing on the same team, a small set of opponent key-players which affect the performance of the athlete when they are playing against him/her, the team playing against the athlete, the overall team performance, the stage in the season, and incidents like injuries or other events expected to affect the performance of the player.

The athlete-performance predictor component 242 can model the above statistics against actual performance to generate logic that predicts future performance given the same input. The modeling phase can be an ongoing process combining multiple outputs from several data mining and statistical models as input to constantly tune the prediction model.

The athlete-performance predictor component 242 can generate predictions for a number of different scenarios including: a probability for the winner of a match, a probability for certain levels of team performance, a probability for certain levels of player performance, and a probability for certain scores/categories of scores.

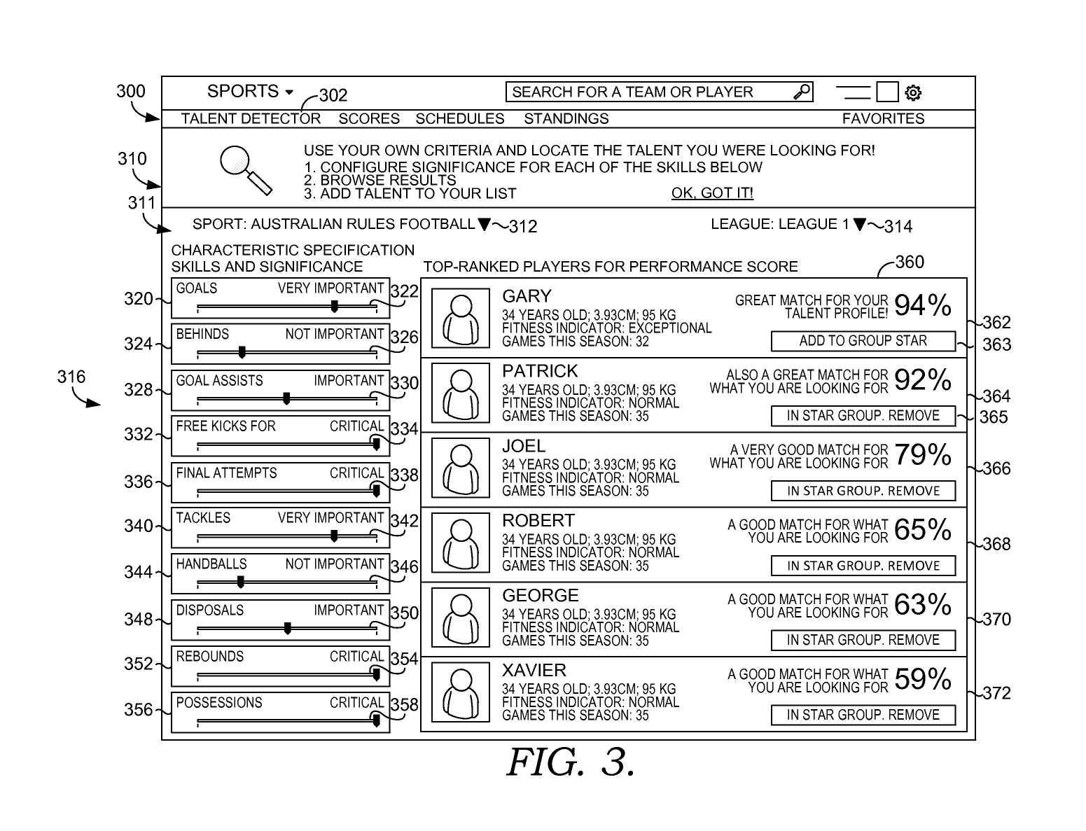

The user interface component 244 generates a user interface that can allow the user to specify weights on the variables for the specific sport which are used to generate an overall performance score for each athlete in the talent pool. The variables and other input provided by the user may be received through the interface. The user input can be stored in the data store 228. The user profile can include a plurality of customized performance score models generated, saved, and maintained by the user. The user interface component 244 can also output a list of athletes along with the performance scores associated with those athletes. An exemplary interface generated by the user interface component 244 is shown in FIG. 3.

Turning now to FIG. 3, a performance-driven athlete performance search engine interface 300 is shown, in accordance with an aspect of a technology described herein. The performance-driven athlete performance search engine interface 300 shown in FIG. 3 is depicted in a web browser. Aspects of the technology described herein are not limited for use with a web browser. For example, performance interfaces could be generated by an application dedicated to athlete performance, among other examples.

In one aspect, the performance-driven athlete search engine interface 300 can be accessed under a sports vertical on a search page. The sports vertical may offer multiple subcategories or tabs, such as talent detector, scorers, schedules, and standings. As an example, the interface shown in FIG. 3 could be accessed by selecting the talent detector tab 302.

The instruction section 310 provides tips for using the performance-driven athlete performance interface 300. The instructions shown are exemplary. Actual instructions could vary.

The talent pool definition interface 311 allows the user to select from available sports through the sport-selection interface 312. In this example, the sport selected is Australian Rules Football. Once a sport is selected, other talent pool criteria may be displayed, such as in the league-selection interface 314. The league-selection interface allows the user to limit the performance analysis to a particular league of Australian Rules Football. The league-selection interface 314 shows League 1 selected. Accordingly, the performance analysis would be performed on athletes in League 1 of Australian Rules Football. The league-selection interface 314 could automatically provide a drop-down menu for Australian Rules Football leagues where data is available for athlete analysis. The talent pool definition interface may include additional criteria, such as time related, geo-location, or market related.

The performance-variable adjustment interface 316 allows the user to set significance (weights) on each performance variable. In one aspect, all available performance variables for a selected sport are shown in the interface to allow the user to select the weight. In other aspects, a pop-up interface or other mechanism is provided for selecting a plurality or subset of variables available for a particular sport. The drop-down interface allows the user to designate which available variables to be used, and with what significance, to form the overall adjusted athlete performance score.

In this example, the first variable interface 320 is for goals scored. A slider control 322 is used to set the significance to be applied to goals in the calculation of the adjusted overall athlete performance score. Here, the significance is set to “very important.” Though not shown in the example of FIG. 3, as the user slides the slider control 322, then the description of the user's assigned weight can change. The actual significance used in the calculation of the performance score can be a number. In one example, the significance is measured using a number between 0 and 1, with very important variables assigned a 1.

The second variable interface 324 is behinds. The slider control 326 is set to a weight of “not important.”

The third variable interface 328 is set to goal assists. The slider control 330 is set to important.

The fourth variable interface 332 is set to free kicks for. The slider control 334 is set to critical.

The fifth variable interface 336 is set to final attempts. The slider control 338 is set to critical importance.

The sixth variable interface 340 is set to tackles. The corresponding slider control 342 is set to very important.

The seventh variable interface 344 is set to handballs. The corresponding slider control 346 is set to not important.

The eighth variable interface 348 is set to disposals. The corresponding slider control 350 is set to important.

The ninth variable interface 352 is set to rebounds. The corresponding slider control 354 is set to critical.

The tenth variable interface 356 is set to possessions and the corresponding slider control 358 is set to critical.

The selected performance indicators and their associated weights can be used to calculate overall, adjusted performance scores for athletes in League 1 of the Australian Rules Football (the defined talent pool). These athletes may be ranked according to the performance score. The top ranked athletes according to the performance score are shown in Search Results Section 360. Each result can include various information about an athlete along with the actual performance score. In this case, the top search result 362 is about an athlete named Gary. Gary is 34 years old and has played 32 games this season. The top search result 362 also includes a fitness indicator. The fitness indicator for Gary is exceptional. The fitness indicator may be an implicit classification of an athlete's performance derived from descriptions of the athlete activities in various commentaries (social, formal game commentaries and discussions) and also through time series analysis of athlete's performance. Time series analysis unveil trends, seasonal patterns and cyclic patterns regarding the performance of an athlete. These patterns can be used to understand the shape/energy/physical level at which the athlete is currently at, along with the expected performance for any time point, including time points in the future. By comparing the expected performance of the player with the actual one, and also combining publicity score, team synthesis information, competitor team synthesis and state and the difficulty of the match, the system estimates and quantifies the shape of the athlete. Gary's fitness indicator of exceptional could be caused by sports commentary indicating that Gary is tireless, has excellent endurance, is relentless, etc., which is also compared to the expected performance as measured against commentary for other athletes.

The top search result 362 includes a group monitoring option 363. The group monitoring option offers to add Gary to the Star Group associated with the user requesting the performance analysis. A user may have multiple monitor groups for individual sports leagues or other categories.

The second search result 364 shows data for Patrick. Patrick is already in the user's monitoring group, thus the monitoring interface 365 asks whether the user wants to remove Patrick from the Star Group.

The third search result 366 describes information about an athlete named Joel. The fourth search result 368 shows information related to an athlete named Robert. The fifth search result 370 describes information about an athlete named George. The sixth search result 372 shows information about an athlete named Xavier.

As soon as the user changes any of the weights assigned to the performance variables, through changing the value of any of the controls (sliders) 322 through 358, the system automatically readjusts the score for the entire athlete pool and re-ranks the result. For any different weight factors, the overall performance score for each athlete in the talent pool may be different, thus the overall ranking possibly different.

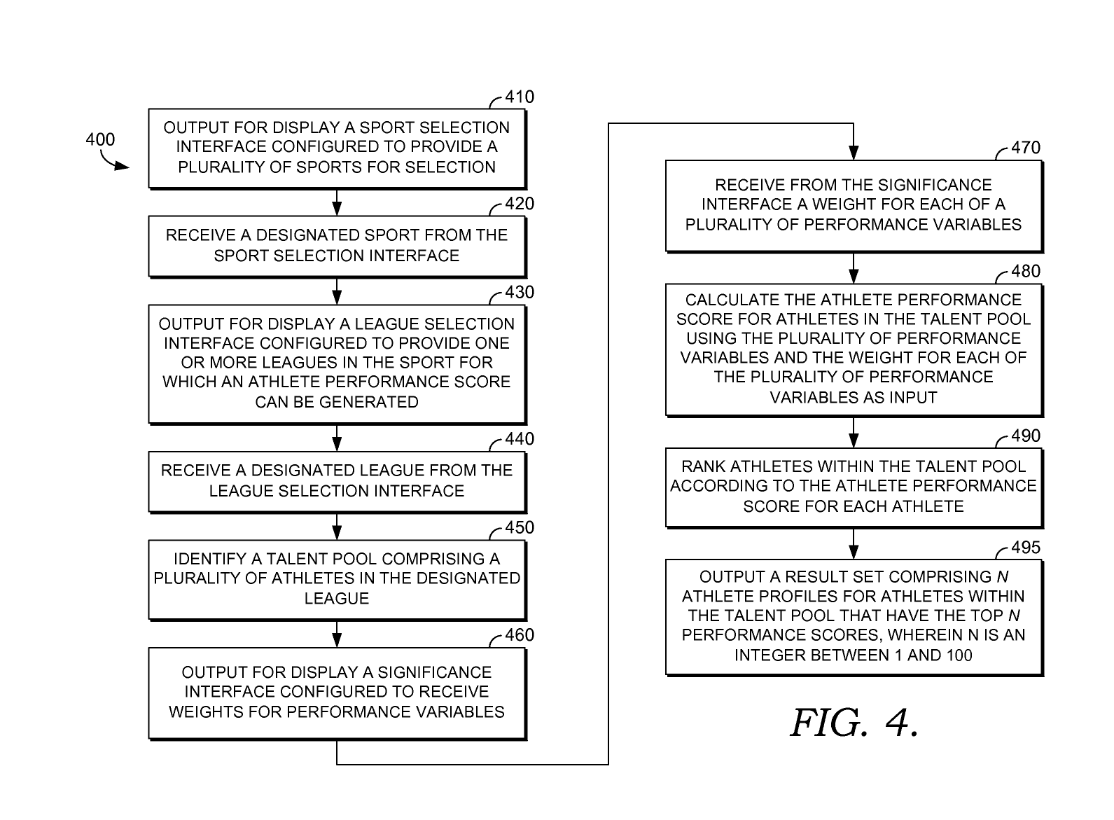

Turning now to FIG. 4, a method 400 for generating an athlete performance score is provided. Method 400 can be performed by a computing device that comprises a relational database storing sports data and athlete data. The computing device can also include a processor, a display interface, and an input interface. The display interface is configured to generate interfaces that can be displayed to a user through a display device. The input interface is configured to receive information from an interface provided by the display device. The information can be stored in the relational database and used by the processor to generate updated datasets. The processor, input interface, and display interface can each be configured by execution of computer instructions.

At step 410, a sport-selection interface configured to provide a plurality of sports for selection is output for display. In one aspect, the display interface is configured to generate the sport-selection interface. The interface can be generated by the display interface by accessing computer code, that when executed, causes a graphics pipeline associated with a computing device to render the sport-selection interface. Once the code is accessed, the display interface can cause the code to be communicated, for example over a network connection, to an application that can read the code and cause an interface based on the code to be generated.

The sport-selection interface can be generated by a web server communicating a webpage to a web browser application on a user device. The interface is then displayed to the user via a screen associated with the user device. In one aspect, a drop-down menu is provided listing sports from which statistics are available to calculate an athlete performance score. Other types of menus can be used, for example, a list with radial buttons or check boxes. The-sport selection interface may be part of a search interface web page, a sports-oriented commentary website, or some other interface.

At step 420, a designated sport is received from the sport-selection interface. In one aspect, an input interface is configured to receive the selection of the designated sport. The input interface can be an application program interface associated with a web server. The application program interface can receive information formatted according to a particular schema and provide the information to another component, such as a processor, running a program that identifies a talent pool. In one aspect, a user selected one of several available sports presented in the sport selection interface. The sport selection can be converted to a specific output indicating the selection by the browser and communicated across a computer network to a web server. The web server can then store the selection. The selection could also be saved on the user device.

At step 430, a league selection interface configured to provide one or more leagues in the sport for which an athlete performance score can be generated is output for display. In one aspect, the display interface is configured to generate the league selection interface. In one aspect, a drop-down menu is provided listing leagues in the sport from which statistics are available to calculate an athlete performance score. Other types of menus can be used, for example, a list with radial buttons or check boxes. The league selection can be converted to a specific output indicating the selection by the browser and communicated across a computer network to a web server. The web server can then store the selection. The selection could also be saved on the user device.

At step 440, a designated league is received from the league selection interface. As mentioned, the designated league could be received from the browser application over a network connection. The input interface could be configured to receive the selection of the designated league.

At step 450, a talent pool comprising a data set identifying a plurality of athletes in the designated league is identified. In one aspect, the processor can be configured to generate the talent pool. The processor can receive the designated league and designated sports as input. The processor can access a data store to identify all athletes in the league. Additional filter criteria, other than the designated league, can be provided. In one aspect, a predefined talent pool or filter criteria is specified. The user can generate talent pools by selecting athletes individually or by criteria, such as performance variables, team affiliation, etc. Once a user defines a talent pool, the definition can be saved and used subsequently.

In another aspect, the talent pool is defined using a criteria specified by the user. The criteria can act as a filter. For example, athletes in the selected league meeting one or more criteria (e.g., age, position, statistical range) can be used to identify the talent pool by comparing athletes in the league with the criteria. Athletes that satisfy the criteria are included and athletes that do not satisfy the criteria are excluded.

In one aspect, a performance variable interface configured to receive a selection of performance variables to be used to calculate the athlete performance score can be output for display. The performance variables can be specific to the sport and/or league selected. The interface can receive a selection comprising the plurality of performance variables. The selected performance variables can then be provided in a significance interface. The performance variables can include sports statistics, which is a record of the athlete's performance in one or more athletic events within the selected sport and league. The performance variables can also include a selection mechanism for other variables, such as explicit and implicit physical characteristics of an athlete.

In one aspect, at least one of the plurality of performance variables comprises an implicit classification against specific physical aspects of the athlete, such as physical condition, physical strength, sports intelligence, etc. The classification can be derived, at least in part, by using natural language processing to identify sports commentary describing the activities and performance of the athlete. In another aspect, the implicit classification can be calculated through video analysis of an athlete's performance in a sporting event. For example, an athlete's speed could be derived from determining how far the athlete ran during a duration of video. Distance could be determined using landmarks on an athletic field, such as between bases in baseball and yard markers in football. Other methods of determining distance are possible.

In one aspect, an explicit measure of a physical characteristic for an athlete is used to adjust the athlete performance score. The explicit measure of a physical characteristic can include an athlete's height, weight, age, hand size, arm length, hometown, nationality, and certain tested performance variables, such as 40-yard dash time, bench press, squat, shuttle time, vertical jump, long jump, etc. The explicit measures can be extracted from a knowledge base that describes athlete characteristics, statistics, and performance variables.

At step 460, a significance interface configured to receive weights for performance variables is output for display. In one aspect, the display interface is configured to generate the significance interface. In one aspect, the weight is assigned on a scale ranging between 1 and 100. Other scales are possible. In one aspect, the scale includes an option to assign zero weight. Assigning zero weight effectively removes the corresponding performance variable from the calculation. Providing the option to assign zero weight can be useful when the user is not given the option to select the performance variables in the first place. However, providing an option to assign zero weight to a variable can be provided in any circumstance, including when the user selects the performance variables. The significance interface allows the user to provide different weights for different variables. For example, in baseball, a weight of 50 could be given to Runs, a weight of 37 could be given to RBIs, a weight of 70 could be given to on-base percentage, and a weight of 50 could be given to slugging percentage. Notice that the same or different weights can be assigned to each variable. The assignment of weight to an individual variable can be independent of the weights assigned to other variables.

In one aspect, the interface provides an annotation helping the user understand the significance of an assigned weight. For example, assigning a weight between 1-33 could result in presentation of an annotation stating “not important,” assigning a weight between 34 and 66 could result in presentation of an annotation stating “medium importance,” and assigning a score between 67 and 100 could result in presentation of an annotation stating “very important.” Other variations on the annotation, ranges, and number of ranges and corresponding annotations are possible.

At step 470, a weight for each of a plurality of performance variables is received from the significance interface. In one aspect, the input interface is configured to receive the weights from the significance interface. The weight can be input through a user interface. The input defining the weight can be converted to a specific output indicating the selection by the browser and communicated across a computer network to a web server. The web server can then store the selection. The selection could also be saved on the user device.

At step 480, the athlete performance score for athletes in the talent pool is calculated using the plurality of performance variables and the weight for each of the plurality of performance variables as input. In one aspect, the processor is configured to calculate the athlete performance score. The athlete performance score may be calculated as described previously.

The athlete performance score can be calculated over a time frame. The time frame can be defined by dates, sports seasons, portions of seasons (e.g., first half, second half), tournaments (e.g., playoffs, bowl games, major tournaments), or other measures.

At step 490, athletes within the talent pool are ranked according to the athlete performance score for each athlete. In one aspect, the processor is configured to generate a ranked list of athletes according to the performance score calculated for each athlete. In one aspect, the performance scores associated with the athletes can be input into a sorting algorithm to generate an ordered list of athletes.

At step 495, a result set comprising N athlete profiles for athletes within the talent pool that have the top N performance scores is output. In one aspect, the display interface is configured to output the result set. In one aspect, N is an integer between 1 and 100. N can be defined by a user. In one aspect, the result set includes an athlete summary for each athlete in the result set. The summary can include a picture of the athlete, statistics and characteristics, the athlete performance score, the rank, and other interface features. For example, the summary can include an option to follow the athlete if the user wishes to receive updates about the athlete's performance score. The user may add the athlete to one or more groups of athletes the user wishes to follow or analyze over time. In one aspect, a combined athlete performance score is calculated for each group to allow the user to compare groups. In one aspect, a group management interface is provided that allows the user to change performance variables and corresponding weights to see how ranks and scores change for athletes in the group. Criteria used to calculate an athlete performance score can be saved for subsequent use by the user. Saved criteria can then be applied in the future to an established group or to start a new search.

An aspect of the technology can generate and output a trend analysis interface. The trend analysis interface can show how an athlete performance score changes over time using a graph, or some other presentation format. The trend analysis can show a single athlete's trend, the trends for multiple athletes, a group trend, or such.

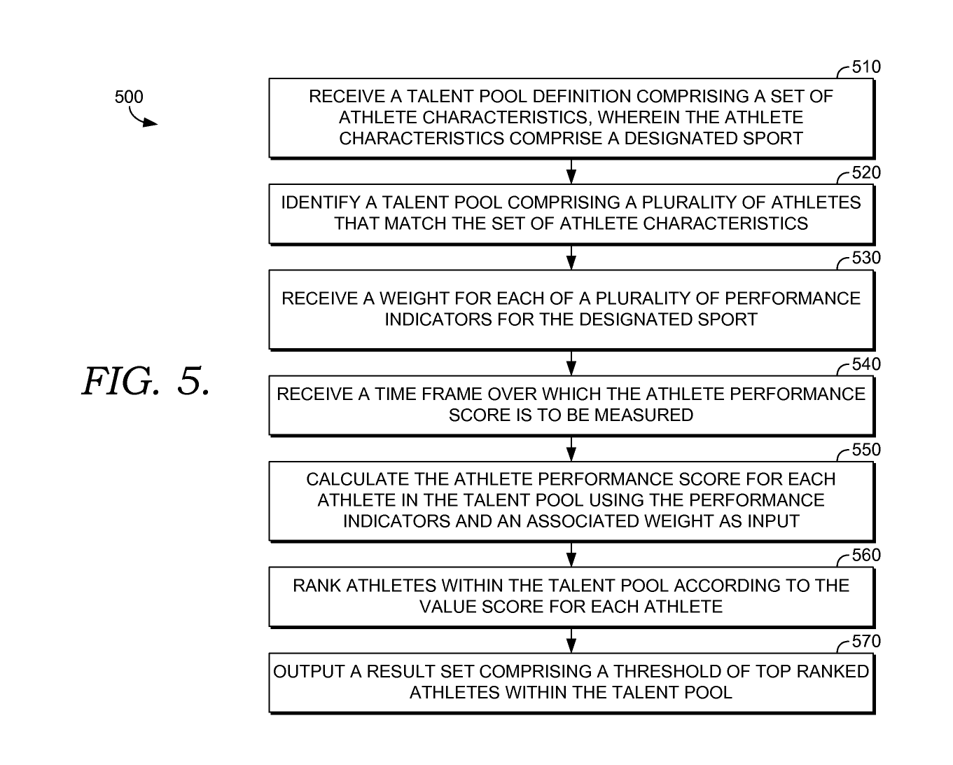

Turning now to FIG. 5, a method 500 for generating an athlete performance score is provided. Method 500 can be performed by a server that presents results over a network interface or by a local client device.

At step 510, a talent pool definition comprising a set of sport/athlete characteristics is received. The set of sport/athlete characteristics comprise a designated sport and other characteristics used to define the talent pool. For example, the athlete characteristics can include a sports league, a sports team, an age range, years in the league, and/or a player nationality. The talent pool definition can be selected by a user from a plurality of talent pool definitions previously created by the user. In another aspect, a selection of talent pool definitions can be provided to the user from a group of options selected to appeal to the user based on a user profile. For example, if the user has a known interest in rugby, then a group of talent pool definitions related to rugby could be provided. The set of athlete characteristics used to define the talent pool can comprises a position on a sports team. For example, the talent pool could be all quarterbacks in a football league.

At step 520, a talent pool comprising a plurality of athletes that match the set of athlete characteristics in the talent pool definition is identified. The talent pool can be identified a number of ways. In one aspect, a predefined talent pool or filter criteria is specified. The user can generate talent pools by selecting athletes individually or by criteria, such as performance variables, team affiliation, etc. Once a user defines a talent pool, the definition can be saved and used subsequently.

In another aspect, the talent pool is defined using a criteria specified by the user. For example, athletes in the selected league meeting one or more criteria (e.g., age, position, statistical range) can be used to identify the talent pool by comparing athletes in the league with the criteria. Athletes that satisfy the criteria are included and athletes that do not satisfy the criteria are excluded.

At step 530, a weight for each of a plurality of performance variables for the designated sport is received. For example, the weights could be provided through an interface such as interface 300.

At step 540, a time frame over which the athlete performance score is to be measured is received. The time frame can be defined by dates, sports seasons, portions of seasons (e.g., first half, second half), tournaments (e.g., playoffs, bowl games, major tournaments), or other measures. The time frame can include a historical period, such a 1932.

At step 550, the athlete performance score for each athlete in the talent pool is calculated using the performance variables and associated weights as input. The athlete performance score may be calculated as described previously.

At step 560, athletes within the talent pool are ranked according to the athlete performance score for each athlete. For example, the athlete with the highest score could be ranked first, the second highest score could ranked second, and so on.

At step 570, a result set comprising a subset of top ranked athletes within the talent pool is output for display. In one aspect, the top ten athletes are presented in the result set. Each athlete can be presented as part of an athlete summary that shows information about the athlete.

Turning now to FIG. 6, a method 600 of monitoring an external device status on behalf of an application installed on a computing device is provided.

At step 610, a talent pool comprising a plurality of athletes that play a designated sport is identified. The talent pool can be identified based on a previously supplied talent pool definition. Alternatively, individual talent pool characteristics, including the designated sport, can be provided.

At step 620, a weight for each of a plurality of performance variables for the designated sport is received.

At step 630, an athlete performance score is calculated for each athlete in the talent pool using the performance variables and an associated weight as input into a linear model that outputs the athlete performance score. Calculation of the athlete performance score has been described previously.

At step 640, a result set comprising athletes and a performance score calculated for the athletes is output for display. The result set can include the top ranked athletes according to the performance scores.

### Exemplary Operating Environment

Referring to the drawings in general, and initially to FIG. 7 in particular, an exemplary operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.” The computing device 700 may be a PC, a tablet, a smartphone, virtual reality headwear, augmented reality headwear, a game console, and such.

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, vibrating component, etc. I/O ports 718 allow computing device 700 to be logically coupled to other devices, including I/O components 720, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separate from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

The computing device 700 may include a radio 724. The radio transmits and receives radio communications. The computing device 700 may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A computing device comprising:
a database configured to store sports data and athlete data, wherein the sports data comprises a plurality of sports, and wherein the athlete data comprises performance variables and associated values for the performance variables;
a display interface operatively coupled to the database and configured to generate a sport selection interface to provide a plurality of selectable fields based on the sports data;
an input interface configured to receive a selection from the display interface indicating a designated sport;
a processor configured to identify a talent pool data set comprising a subset of athlete data from the relational database for athletes in the designated sport;
the display interface further configured to generate a significance interface configured to receive weights for performance variables;
the input interface further configured to receive from the significance interface a weight for each of a plurality of performance variables;
the processor further configured to calculate an athlete performance score for athletes in the talent pool using the plurality of performance variables and the weight for each of the plurality of performance variables as input; and
the display interface further configured to generate a performance score interface comprising a result set comprising N athlete profiles for athletes within the talent pool that have the top N performance scores.

2. The computing device of claim 1, wherein the display interface is further configured to generate a performance variable interface configured to receive a selection of performance variables to be used to calculate the athlete performance score and the input interface is further configured to receive a selection from the performance variable interface comprising the plurality of performance variables.

3. The computing device of claim 2, wherein the athlete performance score for athletes is calculated by also using an implicit classification of a physical characteristic for an athlete as input, the implicit classification calculated, at least in part, by using natural language processing to identify and process sports commentary that describe the physical characteristic and performance of the athlete.

4. The computing device of claim 3, wherein the implicit classification comprises one of speed, strength, physical fitness, or sports intelligence.

5. The computing device of claim 2, wherein the athlete performance score for athletes is adjusted by one or more explicit measure of a physical characteristic for an athlete, the explicit measure extracted from a knowledge base that describes athlete characteristics.

6. The computing device of claim 2, wherein the plurality of performance variables comprise an implicit classification of a physical characteristic for an athlete, the implicit classification derived by a video analysis of a sports event.

7. The computing device of claim 1, wherein the display interface is further configured to generate an athlete tracking interface configured to receive a selection of an athlete, wherein the input interface is further configured to receive a selection of an athlete through the athlete tracking interface, and wherein the processor is further configured to add the athlete to a monitoring group associated with the user in the database.

8. The computing device of claim 7, wherein the display interface is further configured to generate a trend interface configured to communicate how the athlete performance score for one or more athletes in the monitoring group changes over time.

9. A method of generating an athlete performance score comprising:
receiving a talent pool definition comprising a set of athlete characteristics, wherein the set of athlete characteristics comprise a designated sport;
identifying a talent pool comprising a plurality of athletes that match the set of athlete characteristics;
receiving a weight for each of a plurality of performance variables for the designated sport;
receiving a time frame over which the athlete performance score is to be measured;
calculating the athlete performance score for each athlete in the talent pool using the performance variables and an associated weight as input;
ranking athletes within the talent pool according to the athlete performance score for each athlete; and
outputting a result set comprising a subset of top ranked athletes within the talent pool.

10. The method of claim 9, wherein the set of athlete characteristics used to define the talent pool comprises a position on a sports team.

11. The method of claim 9, further comprising:
outputting for display to a user an interface that comprises the plurality of performance variables and adjacent to each of the plurality of performance variables a control to set the weight for the corresponding performance variable.

12. The method of claim 9, wherein the method further comprises calculating an athlete publicity score for each athlete by:
identifying a corpus of sports commentary published during the time frame that describes an athletic event in which one or more athletes in the talent pool participated using an automated classifier;
analyzing the corpus of sports commentary using a natural language processor to determining an amount of mentions for each athlete in the talent pool; and
generating the athlete publicity score for an athlete by comparing the amount of mentions against a baseline amount of mentions for the athlete.

13. The method of claim 12, wherein the baseline amount of mentions is an average amount of mentions for athletes playing the same position as the athlete.

14. The method of claim 9, further comprising estimating a speed characteristics for an athlete by analyzing video of the athlete during a sporting event that occurred during the time frame to determine a velocity obtained by the athlete.

15. The method of claim 9, wherein the time frame has a start date and an end date more than one year previous from a current date.

16. A method of monitoring an external device status on behalf of an application installed on a computing device, the method comprising:
identifying a talent pool comprising a plurality of athletes that play a designated sport;
receiving a weight for each of a plurality of performance variables for the designated sport;
calculating an athlete performance score for each athlete in the talent pool using the performance variables and an associated weight as input into a linear model that outputs the athlete performance score; and
outputting a result set comprising athletes and a performance score calculated for the athlete.

17. The method of claim 16, wherein the method further comprises calculating an athlete publicity score for each athlete by:
identifying a corpus of sports commentary published during a time frame that describes an athletic event in which one or more athletes in the talent pool participated using an automated classifier;
analyzing the corpus of sports commentary using a natural language processor to determining an amount of mentions for each athlete in the talent pool; and
generating the athlete publicity score for an athlete by comparing the amount of mentions against a baseline amount of mentions for the athlete.

18. The method of claim 16, further comprising:
outputting for display to a user an interface that comprises the plurality of performance variables and adjacent to each of the plurality of performance variables a control to set the weight for the corresponding performance variable.

19. The method of claim 16, wherein the athlete performance score for athletes is calculated by also using an implicit classification of a physical characteristic for an athlete as input, the implicit classification calculated, at least in part, by using natural language processing to identify sports commentary that describes the physical characteristic for the athlete.

20. The method of claim 16, wherein the athlete performance score for athletes is calculated by also using an explicit measure of a physical characteristic for an athlete, the explicit measure extracted from a knowledge base that describes athlete characteristics.
